(19) United States
(12) Patent Application Publication
(10) Pub. No.: US 2004/0247375 A1
(43) Pub. Date: Dec. 9, 2004

(54) Index card holder

(76) Inventors: Stephen D. Wehmeyer, Cincinnati, OH (US); Carey L. Walley, Springboro, OH (US)

Correspondence Address: THOMPSON HINE L.L.P., 2000 COURTHOUSE PLAZA , N.E., 10 WEST SECOND STREET, DAYTON, OH, 45402, US

(21) Appl. No.: 10/457,509

(22) Filed: Jun. 9, 2003

(51) Int. Cl. B42F 13/00

(52) U.S. Cl. 402/79

(57) ABSTRACT

A pocket system for attachment to a binding mechanism including a body including an inner cavity sized to closely receive a plurality of index cards therein, the index cards having a size of about 3 inches by about 5 inches. The pocket system further includes an attachment structure coupled to the body and including a pair of spaced openings. Each opening is sized and spaced to receive a ring of a binding mechanism therethrough to couple to the body to the binding mechanism.

The present invention is directed to a pocket for attachment to a binder, and more particularly, to an index card holder for attachment to a binder.

### BACKGROUND

Binders are widely used to store and transport a variety of papers and other materials. Furthermore, index cards are often used as a surface upon which to take notes or serve various other purposes, and may be used in settings similar to those in which binders are used (i.e., in schools, businesses, home offices, etc.). Accordingly, there is a need for a pocket which can store index cards for use with a binder.

### SUMMARY

In one embodiment the present invention is a pocket sized to closely receive an index card or index cards therein, and wherein the pocket can be attached to a binder or binding mechanism. In one embodiment, the invention is a pocket system for attachment to a binding mechanism including a body including an inner cavity sized to closely receive a plurality of index cards therein, the index cards having a size of about 3 inches by about 5 inches. The pocket further includes an attachment structure coupled to the body and including a pair of spaced openings. Each opening is sized and spaced to receive a ring of a binding mechanism therethrough to couple to the body to the binding mechanism.

Other objects and advantages of the present invention will be apparent from the following description and the accompanying drawings.

### BRIEF DESCRIPTION OF THE DRAWINGS

FIG. 1 is a front perspective view of one embodiment of the pocket of the present invention, with the cover shown in its closed position;

FIG. 2 is a rear perspective view of the pocket of FIG. 1;

FIG. 3 is a front perspective view of the pocket of FIG. 1 with the cover in its open location, and shown in conjunction with a set of index cards; and

FIG. 4 is a front perspective view of a binder with the pocket of FIG. 1 mounted thereto.

### DETAILED DESCRIPTION

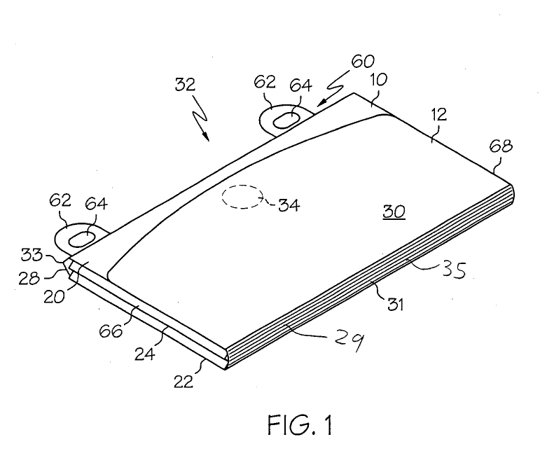

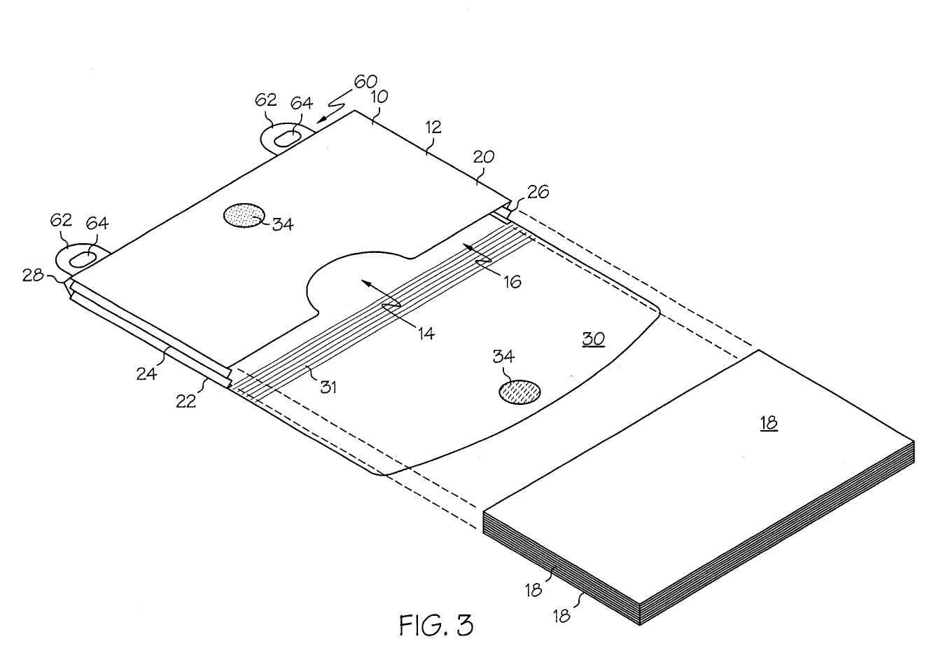

As shown in FIGS. 1-4, the pocket 10 of the present invention may include a body 12 having an inner cavity 14 and a mouth 16 which provides access to the inner cavity 14. The inner cavity 14 may be sized to closely receive an index card 18 or a plurality of index cards therein. In one embodiment, the index cards 18 may have a size of about 3″ by about 5″ such that the inner cavity 14 has width and length dimensions slightly greater than the 3×5 dimensions of the index cards 18. In one embodiment, the body 12 has a width (i.e., the dimension extending perpendicular to the mouth 14) of between about 3″ and about 4½″ and preferably about 3-5/8″ and a length (i.e., the dimension extending parallel to the mouth 14) of between about 5″ and about 6½″, preferably about 5⅝″.

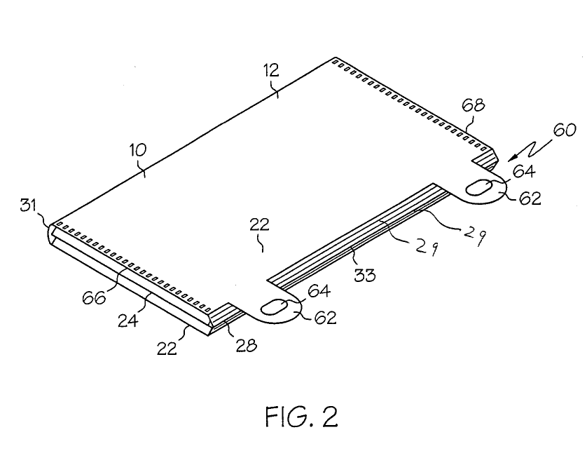

The body 12 may include a front panel 20, a rear panel 22 generally parallel to and spaced apart from the front panel 20, and a pair of expandable side panels 24, 26. Each side panel 24, 26 may be coupled to and extend between the front 20 and rear panels 22. Each side panel 24, 26 may be expandable, such as being made from an accordion-style gusset material to allow for expansion of the side panels 24, 26 and of the pocket 10 or cavity 14 to accommodate a large number of index cards 18. The body 12 may also include a back panel 28 coupled to and extending between the front 20 and rear 22 panels. As shown in FIG. 1, when the pocket 10 is not filled, the back panel 28 may be folded along a crease 33, which can allow the back panel 28 to be pulled taut to a generally vertical position (not shown) to accommodate expansion of the pocket 10. The back panel 28 may be generally flexible, and in the illustrated embodiment includes a plurality of score lines 29 to lend flexibility to the back panel 28 (see FIG. 2).

The pocket 10 may include a cover 30 coupled to the body 12. In the illustrated embodiment, the cover 12 is pivotally coupled to the rear panel 22 and releasably attachable to the front panel 24. In the illustrated embodiment, the cover 30 is formed as an extension of the material of the rear panel 22 with a flexible hinge portion 31 located therebetween. In the illustrated embodiment, the hinge portion 31 includes a plurality of score lines 35 to lend flexibility to the hinge portion 31.

As shown in FIG. 1, when the cover 30 is located in its closed position, the cover 30 may be located over and cover the mouth 16 to generally block access to the cavity 14 and retain any index cards or other contents of the pocket 10 therein. When the cover 30 is in its closed position, the cover 30 may be coupled to the front panel 20 and be generally parallel to the front panel 20 and at least partially overlap or lie on the front panel 20. The pocket 10 may also include a closure mechanism 32 located at least one of the cover 30 or the body 12 to retain the cover 30 in the closed position. In the illustrated embodiment both the cover 30 and the body 12 include a corresponding patch 34 of hook and loop fastening material, such as VELCRO® fastening material, to retain the cover 30 in its closed position. However, any of a wide variety of closure mechanisms, including but not limited to hooks, snaps, clasps, zippers, side closure systems, cords, ties, interengaging flaps, and the like may be used.

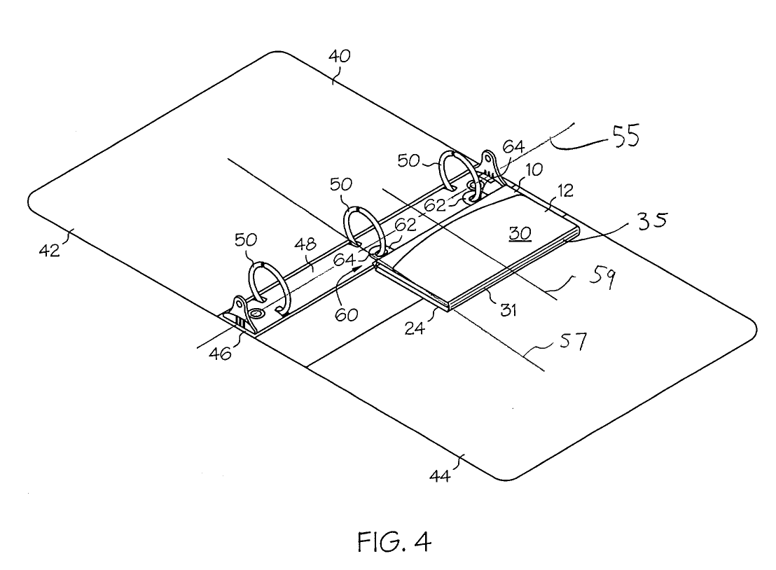

As shown in FIG. 4, the pocket 10 may be arranged and shaped to be coupled to a binder, generally designated 40. For example, the binder 40 may include a front cover 42, a rear cover 44, and a spine 46, with both the front 42 and rear 44 covers being pivotally coupled to the spine 46. The binder 40 may include a three-ring binding mechanism 48 coupled to the spine, with each ring 50 of the binding mechanism 48 being separable to allow papers to be placed into or removed from the binder 40 by locating each ring through a hole of a piece of paper. In one embodiment, the rings 50 may be spaced apart between about 3½″ to about 5″, or about 4⅛″.

The pocket 10 may include an attachment structure 60 coupled to the body 12 to allow the body 12 to be coupled to the binding mechanism 48. In particular, the attachment structure 60 may include a pair of spaced tabs 62 coupled to and extending generally outwardly from the body 12. Each tab 62 may include an opening 64 sized and spaced to receive a ring 50 of the binding mechanism 48 therethrough to couple the pocket 60 to the binder 40. Each opening 48 may be generally elongate or oval shaped to accommodate variances in the location of the rings 50.

In the illustrated embodiment, the openings 48 are arranged to receive adjacent rings therethrough. In this case, the openings 48 may be spaced apart between about 4⅛″ inches on center. The pocket 10 may include a left side edge 66 and a right side edge 68, and one of the openings 64 may be located adjacent the left side edge 66 and the other opening 64 may be located adjacent the right side edge 68 such that there are generally no openings located between the pair of openings 44.

Thus, it can be seen that the pocket 10 of the present invention can be easily coupled to and uncoupled from the binding mechanism 48 of the binder 40. When the pocket 10 is coupled to the binding mechanism 48, the pocket 10 provides an easily accessible structure for storing index cards or other components. Furthermore, the pocket 10 can be easily uncoupled from and coupled to the binding mechanism 48 should it be desired to move the pocket 10 to another binder 40, or use the pocket 10 in a stand-alone mode.

Furthermore, the pocket 10 may be sized such that the pocket 10 can be coupled to only two rings 50 of a binding mechanism 48. Because the pocket 10 may be coupled to only two rings 50 of the binding mechanism 18, the pocket 10 can be more easily coupled to, and uncoupled from, the binding mechanism 48. Furthermore, the pocket 10 provides a low profile, compact arrangement for storing index cards 18. For example, two pockets 10 may be stored side-by-side on a single binding mechanism 48 such that one pocket 10 is located on the upper two rings 50 of a binding mechanism 48 and the other pocket 10 is located on the lower two rings 50 of the binding mechanism 48. Furthermore, the pocket 10 can be moved to various positions along the length of the binding mechanism 48 to accommodate other items stored in the binder 40. In other words, as shown in FIG. 4 the binding mechanism 48 may include a longitudinal centerline 55 and a lateral centerline 55 (i.e. which extends laterally across the binding mechanism 48 and through center ring 50). In this case the pocket 10, or a lateral centerline 59 of the pocket 10, may be offset relative to the lateral centerline 57 of the binding mechanism 48. Furthermore, the binding mechanism 48 and pocket 10 may be configured such that when the pocket 10 is coupled to the binding mechanism 48 the lateral centerline 59 of the pocket 10 must be offset from, or not aligned with, the lateral centerline 57 of the binding mechanism 48.

Having described the invention in detail and by reference to the preferred embodiments, it will be apparent that modifications and variations thereof are possible without departing from the scope of the invention.

What is claimed is:

1. A pocket system for attachment to a binding mechanism comprising:
a body including an inner cavity sized to closely receive a plurality of index cards therein, said index cards having a size of about 3 inches by about 5 inches, said body including a mouth for providing access to said inner cavity, said body having an outer perimeter and further including a first outer edge extending along said outer perimeter and a second outer edge extending along said outer perimeter and generally parallel to said first edge and located on a generally opposite side of said body relative to said first edge, said mouth being located adjacent to said first edge; and
an attachment structure coupled to said body and including a pair of spaced openings, each opening being sized and spaced to receive a ring of a binding mechanism therethrough to couple said body to said binding mechanism, said attachment structure being located adjacent to said second edge.

2. The pocket system of claim 1 wherein said body includes a front panel, a rear panel generally parallel to and spaced apart from said front panel, and a pair of expandable side panels, each side panel being coupled to and extending between said front and rear panel.

3. The pocket system of claim 2 wherein each side panel is an accordion-style gusset.

4. The pocket system of claim 2 wherein said body includes a back panel coupled to and extending between said front and rear panels.

5. The pocket system of claim 1 wherein said body further includes a cover shaped to selectively cover said mouth.

6. The pocket system of claim 5 wherein said cover is pivotally coupled to said rear panel and is releasably attachable to said front panel.

7. The pocket system of claim 6 wherein said cover is located in a closed position when said cover is coupled to said front panel, and wherein when said cover is in said closed position said cover is generally parallel to said front panel and at least partially lies on said front panel.

8. The pocket system of claim 5 further including a closure mechanism located on at least one of said cover or said body to retain said cover in a closed position such that said cover generally covers said mouth.

9. The pocket system of claim 8 wherein said closure mechanism includes a portion of hook and fastener material located on at least one of said cover or said body.

10. The pocket system of claim 1 wherein said attachment structure includes a pair of spaced tabs coupled to and extending generally outwardly from said body, each tab including one of said openings located therein.

11. The pocket system of claim 1 wherein said body has a width of between about 3 and about 4½ inches and a length of between about 5 and about 6½ inches.

12. The pocket system of claim 1 wherein said openings are spaced apart about 4⅛ inches on center.

13. The pocket system of claim 1 wherein said body includes a left side edge and a right side edge, wherein one of said openings is located adjacent said left side edge and the other of said openings is located adjacent said right side edge, and wherein there are generally no openings located between said pair of openings.

14. The pocket system of claim 1 further including a binder including a binder body having a front cover and a rear cover pivotally joined together, and a three ring binding mechanism located on an inner surface of said binder body, wherein said body is coupled to said three ring mechanism by two rings of said binding mechanism, each of which extends through an associated opening such that a lateral centerline of said body is offset from a lateral centerline of said binding mechanism.

15. A pocket system for attachment to a binding mechanism comprising:
a body including an inner cavity sized to closely receive a plurality of index cards therein, said body including a front panel, a rear panel generally parallel to and spaced apart from said front panel, a pair of expandable side panels, each side panel being coupled to and extending between said front and rear panels, and a mouth for providing access to said inner cavity said body having an outer perimeter and further including a first outer edge extending along said outer perimeter and a second outer edge extending along said outer perimeter and generally parallel to said first edge and located on a generally opposite side of said body relative to said first edge, said mouth being located adjacent to said first edge; and
an attachment structure coupled to said body and including a pair of spaced openings, each opening being sized and spaced to receive a ring of a binding mechanism therethrough to couple said body to said binding mechanism, said attachment structure being located adjacent to said second edge.

16. The pocket system of claim 15 wherein said inner cavity is sized to closely receive a plurality of index cards therein having a size of about 3 inches by about 5 inches.

17. The pocket system of claim 15 wherein each side panel is an accordion-style gusset.

18. The pocket system of claim 15 wherein said body includes a back panel coupled to and extending between said front and rear panels.

19. The pocket system of claim 15 wherein said body further includes a cover shaped to selectively cover said mouth.

20. The pocket system of claim 19 wherein said cover is pivotally coupled to said rear panel and is releasably attachable to said front panel.

21. The pocket system of claim 19 wherein said cover is located in a closed position when said cover is coupled to said front panel, and wherein when said cover is in said closed position said cover is generally parallel to said front panel and at least partially lies on said front panel.

22. The pocket system of claim 19 further including a closure mechanism located on at least one of said cover or said body to retain said cover in a closed position such that said cover generally covers said mouth.

23. The pocket system of claim 22 wherein said closure mechanism includes a portion of hook and fastener material located on at least one of said cover or said body.

24. The pocket system of claim 15 wherein said attachment structure includes a pair of spaced tabs coupled to and extending generally outwardly from said body, each tab including one of said openings located therein.

25. The pocket system of claim 15 wherein said body has a width of between about 3 and about 4½ inches and a length of between about 5 and about 6½ inches.

26. The pocket system of claim 15 wherein said openings are spaced apart about 4⅛ inches on center.

27. The pocket system of claim 15 wherein said body includes a left side edge and a right side edge, wherein one of said openings is located adjacent said left side edge and the other of said openings is located adjacent said right side edge, and wherein there are generally no openings located between said pair of openings.

28. The pocket system of claim 15 further including a binder including a binder body having a front cover and a rear cover pivotally joined together, and a three ring binding mechanism located on an inner surface of said binder body, wherein said body is coupled to said three ring mechanism by two rings of said binding mechanism, each of which extends through an associated opening such that a lateral centerline of said body is offset from a lateral centerline of said binding mechanism.

29. A pocket for attachment to a binding mechanism comprising:
a body including an inner cavity sized to closely receive a plurality of index cards therein, said index cards having a size of about 3 inches by about 5 inches, said body including a front panel, a rear panel generally parallel to and spaced apart from said front panel, a pair of expandable side panels, each side panel being coupled to and extending between said front and rear panels and being an accordion-style gusset, and a back panel coupled to and extending between said front and rear panels, said body including a mouth which provides access to said inner cavity, and wherein said body further includes a cover shaped to selectively cover said mouth, said cover being pivotally coupled to said rear panel and releasably attachable to said front panel, said cover being located in a closed position when said cover is coupled to said front panel, and wherein when said cover is in said closed position said cover is generally parallel to said front panel and at least partially lies on said front panel, said body further including a closure mechanism to retain said cover in said closed position; and
an attachment structure coupled to said body and including a pair of spaced openings, each opening being sized and spaced to receive a ring of a binding mechanism therethrough to couple said body to said binding mechanism, said attachment structure including a pair of spaced tabs coupled to and extending generally outwardly from said body, each tab including one of said openings located therein.
wherein said mouth is located on a first side of said body and said attachment structure is located on a second side of said body located generally opposite of said first side.

30. The pocket system of claim 5 wherein said cover is directly coupled to said body.
